(19) United States
(12) Patent Application Publication
(10) Pub. No.: US 2002/0129000 A1
(43) Pub. Date: Sep. 12, 2002

(54) XML file system

(76) Inventors: Vikram Pillai, Billerica, MA (US); Joseph Kinsella, Reading, MA (US); Gregory O. Bruell, Carlisle, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/016,493

(22) Filed: Dec. 10, 2001

Related U.S. Application Data
(60) Provisional application No. 60/254,723, filed on Dec. 11, 2000.

(51) Int. Cl. G06F 7/00

(52) U.S. Cl. 707/1

(57) ABSTRACT

A system for providing a name space to a computer program, including a document representing a file system for services available on a computer system. The document defines a name space for the services, and is organized as a tree structure having multiple nodes, such as XML nodes. The nodes include at least one directory node representing a system directory, and at least one file node. A system area within the document defines type attributes corresponding the file nodes and the directory nodes, and which distinguish between the file nodes and the directory nodes. The system area further includes access control attributes for the file nodes in the document, and a physical file attribute corresponding to each the file nodes. The physical file attributes define locations of physical files corresponding to the file type nodes, while the access control attributes specify actions permitted using the physical files.

### CROSS REFERENCE TO RELATED APPLICATIONS

This application claims priority under 35 U.S.C. §119(e) to provisional patent application serial No. 60/254,723, entitled DISTRIBUTED NETWORK MONITORING AND CONTROL SYSTEM, filed Dec. 11, 2000.

### STATEMENT REGARDING FEDERALLY SPONSORED RESEARCH OR DEVELOPMENT

N/A

### BACKGROUND OF THE INVENTION

The present invention relates generally to file systems, and more specifically to a system and method for providing a name space to a computer program.

As it is generally known, there is often a need to provide extensible services in a software system, at what is commonly referred to as the application server level. Traditionally, an application server has consisted of a computer in a client/server environment that performs data processing referred to as “business logic”. In the context of the World Wide Web (“Web”), an application server is typically considered to be a computer in an intranet/Internet environment that performs the data processing necessary to deliver up-to-date information as well as processing information for Web clients. The application server sits along with or between a Web server and any relevant databases, providing the middleware glue to enable a browser-based application to link to multiple sources of information. In existing Java-based application servers the processing is performed by Java servlets, JavaServer Pages (JSPs) and Enterprise JavaBeans (EJBs). In Windows-only environments, the application server processing is performed by Active Server Pages (ASPs) and ActiveX controls. All environments support CGI scripts, which were the first method for tying database contents to HTML (“HyperText Markup Language”) pages.

In large Web sites, separate application servers link to the Web servers and typically provide load balancing and fault tolerance for high-volume traffic. For smaller Web sites, the application server processing is often performed by the Web server. Examples of Web application servers are Netscape Application Server, BEA Weblogic Enterprise, Borland AppServer and IBM's Websphere0 Application Server.

These existing systems, however, generally fail to provide a convenient and easily supported system for supporting extensible functionality that is published by a process or system to another process or system. Accordingly, it would be desirable to have a system which provides a convenient and easily supported system to provide such extensible functionality. Moreover, it would be desirable for such a system to provide a single, hierarchical name space for aggregating XML services. The system should further provide low level system and directory services across all such XML services (e.g. access control, directory listing, documentation), provide a single unified interface to data, and allow interoperability of XML services in the name space.

### BRIEF SUMMARY OF THE INVENTION

Consistent with the present invention, a system for providing a name space to a computer program is disclosed. The disclosed system includes a document representing a file system for services available on a computer system. The document defines the name space for the services, and is organized as a tree structure. The tree structure within the document includes multiple nodes, each of which consists of one or more statements in a definitional markup language, such as XML. The nodes within the document include at least one directory node and at least one file node. The directory nodes of the document together represent a system directory.

The document of the disclosed system further includes a system area, defining at least one type attribute corresponding to each of the file nodes and the directory nodes. The type attributes are used to distinguish between the file nodes and the directory nodes within the document. The system area of the document further includes an access control attribute corresponding to each of the file nodes, and a physical file attribute corresponding to each the file nodes. The physical file attributes define the locations of physical files corresponding to the file type nodes, while the access control attributes specify actions permitted to be performed on or using the physical files by at least one user. Such permitted actions may include, for example, read, write, delete and add actions.

The disclosed system provides a single, hierarchical name space for aggregating XML services. The disclosed system further provides low level system and directory services across all such XML services (e.g. access control, directory listing, documentation), provides a single unified interface to persistence, and allows interoperability of XML services in the provided name space.

### BRIEF DESCRIPTION OF THE SEVERAL VIEWS OF THE DRAWINGS

The invention will be more fully understood by reference to the following detailed description of the invention in conjunction with the drawings, of which:

FIG. 1 shows a distributed system for network management in accordance with an embodiment of the disclosed system;

FIG. 2 is a flow chart illustrating steps performed during operation of an illustrative embodiment of the disclosed system;

FIG. 3 is a flow chart showing steps performed during operation of an illustrative embodiment of the disclosed system in order to establish customer specific information at a remote data center;

FIG. 4 is a flow chart showing steps performed during operation of an illustrative embodiment of the disclosed system upon power up of the disclosed infrastructure management appliance;

FIG. 5 illustrates interactions between the remote data center and the infrastructure management appliance in an illustrative embodiment;

FIG. 6 is a flow chart illustrating steps performed by an illustrative embodiment of the disclosed system to prepare for loading configuration information and/or new functionality into an infrastructure management appliance;

FIG. 7 is a flow chart illustrating steps performed by an illustrative embodiment of the disclosed system to load configuration information and/or new functionality into an infrastructure management appliance;

FIG. 8 shows an illustrative embodiment of the disclosed system for providing a namespace to a computer program;

FIG. 9 shows code for a directory node provided in an illustrative embodiment of the disclosed namespace document;

FIG. 10. shows code for a file node provided in an illustrative embodiment of the disclosed namespace document;

FIG. 11 shows code for an example of a file element within the system area of the illustrative embodiment of the disclosed namespace document;

FIG. 12 shows an example of code in the illustrative embodiment of the disclosed namespace document including access control attributes;

FIG. 13 shows an example of code in the illustrative embodiment of the disclosed namespace document including physical file attribution;

FIG. 14 shows an example of code in the illustrative embodiment of the disclosed namespace document including indication of an executable file;

FIGS. 15(a) and 15(b) show an illustrative example of the disclosed namespace document;

FIG. 16 shows an illustrative example of the disclosed add command;

FIG. 17 shows an illustrative example of the disclosed add command, including addition of an XML file;

FIG. 18 shows an illustrative example of the disclosed add command, including addition of an executable;

FIG. 19 shows an illustrative example of the disclosed add command, including specification of a number of permissions;

FIG. 20 shows an illustrative example of a reply output for the disclosed add command;

FIG. 21 shows an illustrative example of the disclosed copy command;

FIG. 22 shows an illustrative example of the disclosed move command;

FIG. 23 shows an illustrative example of the disclosed remove command;

FIG. 24 shows an illustrative example of a replay output for the disclosed copy, move and remove commands;

FIG. 25 shows an illustrative example of the disclosed directory command;

FIG. 26 shows an illustrative example of a reply to the disclosed directory command;

FIG. 27 shows a second illustrative example of a reply to the disclosed directory command;

FIG. 28 shows a second illustrative example of a reply to the disclosed directory command;

FIG. 29 shows an illustrative example of the disclosed execute command; and

FIG. 30 shows an illustrative example of a reply output to the disclosed execute command.

### DETAILED DESCRIPTION OF THE INVENTION

U.S. Provisional Patent Application Serial No. 60/254,723, entitled DISTRIBUTED NETWORK MONITORING AND CONTROL SYSTEM, filed Dec. 11, 2000, is hereby incorporated herein by reference.

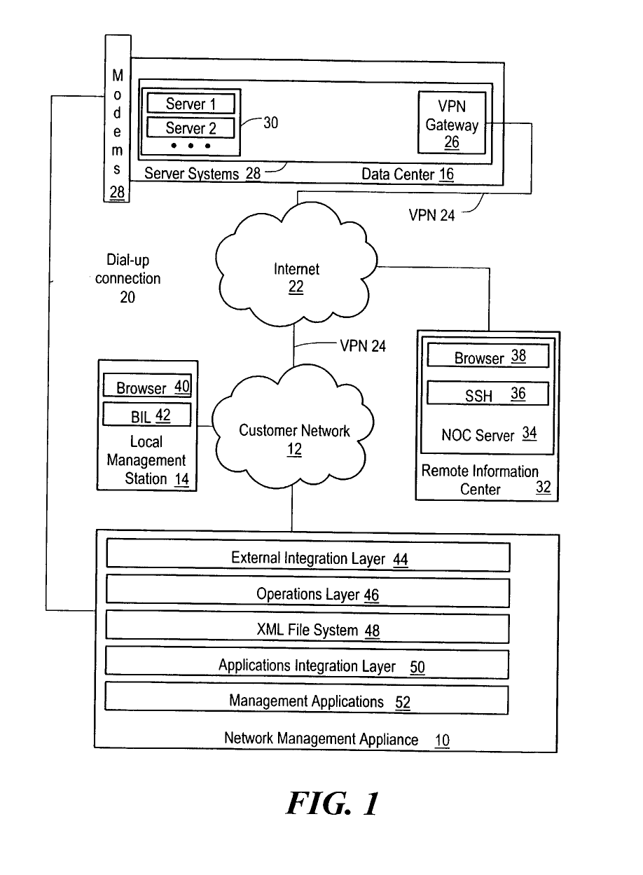

FIG. 1 shows an illustrative embodiment of a distributed system for network management, including an infrastructure management appliance 10 communicably connected to a customer computer network 12. A local management station 14 is also shown connected to the customer computer network 12. The infrastructure management appliance 10 is shown further connected over a dial-up connection 20 to one of a number of modems 18 associated with a Remote Data Center 16.

A secure connection, shown for purposes of illustration as the secure Virtual Private Network (VPN) 24, is used by the infrastructure management appliance 10 to communicate with the Remote Data Center 16 through the internet 22. The infrastructure management appliance 10 may also communicate over the internet 22 with a remote information center 32. While the secure connection 24 is shown for purposes of illustration as a VPN, the present system is not limited to such an embodiment, and any other specific type of secure connection may be used, as appropriate for a given implementation, as the secure connection 24.

The infrastructure management appliance 10 may, for example, consist of a computer system having one or more processors and associated program memory, various input/output interfaces, and appropriate operating system and middleware software. Based on such a hardware platform, the infrastructure management appliance 10 can support various functions of the disclosed system in software. For example, in FIG. 1, the infrastructure management appliance 10 is shown including several layers of software functionality, specifically external integration layer 44, operations layer 46, XML file system 48, applications integration layer 50, and management applications 52.

In the illustrative embodiment of FIG. 1, the applications integration layer 50 is operable to normalize data received from management applications 52 before inserting such data into a database on the infrastructure management appliance 10. The applications integration layer 50 within the infrastructure management appliance 10 operates to provide functionality related to polling, event detection and notification, process control, grouping, scheduling, licensing and discovery.

The external integration layer 44 operates to provide reporting services. In the illustrative embodiment, the external integration layer 44 consists of application server software containing business logic that transforms data inserted into the database by the application integration layer into actionable business information. For example, such a transformation may include converting an absolute number of bytes detected during a period of time moving through a particular port of a customer's device into a percentage of the potential maximum bandwidth for that port used. The external integration layer 44 further operates to perform user management, including management of user preferences, for example as set by customer IT support personnel. These user preferences may, for example, include various user-customizable display parameters, such as the size and order of columns within the user display, and may be managed in cooperation with the browser integration layer 42 in the local management station 14.

The operations layer 46 is the operational portion of the infrastructure management appliance environment, and is the contact point for all communications with the remote data center. In the illustrative embodiment, a master controller process in the operations layer 46 is responsible for provisioning, functionality upgrades and process control within the Infrastructure Management Appliance. Other portions of the operations layer 46 perform remote monitoring, security, trending and paging.

The local management station 14 is also shown including layers of functionality consisting of an Internet browser program 40, and a Browser Integration Layer (BIL) 42. The local management station 14 may also, for example, consist of a computer system, such as a personal computer or workstation, having one or more processors and associated memory, a number of input/output interfaces, and appropriate operating system and middleware software. Accordingly, the functionality layers 40 and 42 may be provided in software executing on the local management station 14. In the illustrative embodiment, the browser integration layer (BIL) 40 includes XSL related functionality that efficiently provides a user-configurable user interface.

The remote information center 32 includes a network operation center (NOC) system 34, which may also be embodied as a computer system including one or more processors, associated memory, various input/output interfaces, and appropriate operating system and middleware software. The NOC system 34 includes an Internet browser program 38, and Secure Shell (SSH) program code 36. The SSH program code 36 is depicted only for purposes of illustration, as an example of an interface and protocol for controlling access to the NOC system 34 within the remote information center 32. During operation of the disclosed system, appliance service support personnel may securely access the Infrastructure Management Appliance 10 through the SSH program code 36 and the browser program 38.

The Remote Data Center 16 is shown including VPN gateway functionality 26, and a number of server systems 28. The server systems 28 may consist of computer hardware platforms, each including one or more processors and associated memories, together with various input/output interfaces, as well as appropriate operating system and middleware software. The server systems 28 support multiple application server software 30. Functionality provided by the servers 30 on the server systems 28 in the Remote Data Center 16 may, for example, include data connectivity, voice connectivity, system control, system monitoring, security, and user services. Specific functions that may be provided by the server software 30 are further described below.

The data connectivity functionality provided by the Remote Data Center 16 includes both software and the modems 18, which serve as backup connectivity between the Remote Data Center 16 and the Infrastructure Management Appliance 10. The data connectivity provided by the Remote Data Center 16 further includes the VPN (Virtual Private Network) gateway 26, supporting the VPN 24, thus providing the primary connectivity between the Remote Data Center and the Infrastructure Management Appliance 10. Data connectivity provided by the server software 30 in the Remote Data Center 16 may additionally include a Web proxy server allowing customer support representatives to access Infrastructure Management Appliances 10 in the field.

The system control functionality provided by the server software 30 in the Remote Data Center 16 may include, for example, provisioning support in the form of a customer service tool for initial and ongoing configuration of the Infrastructure Management Appliance 10, as well as for configuration of data and systems within the Remote Data Center 16.

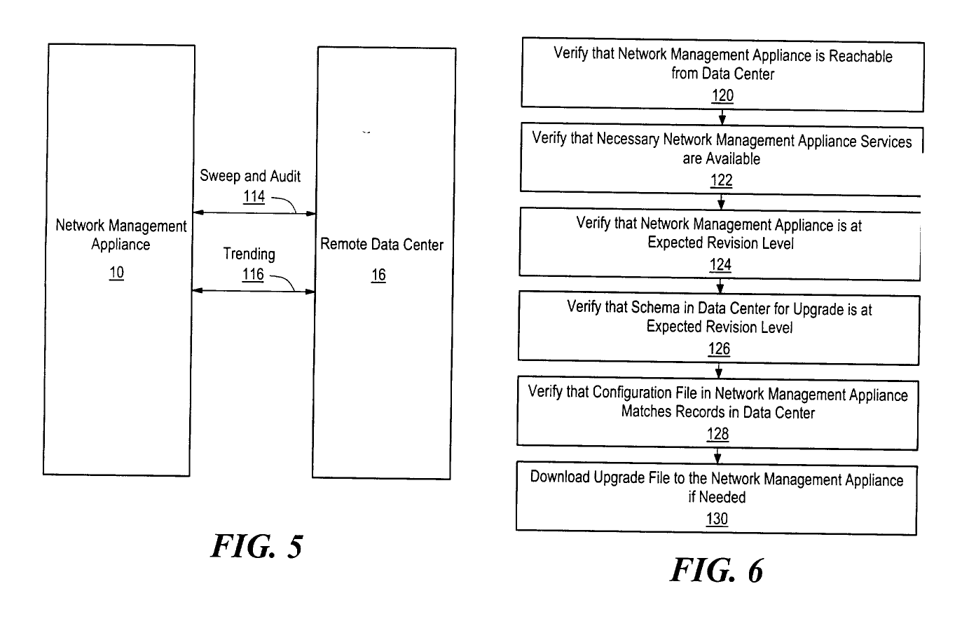

System monitoring functionality provided by the server software 30 in the Remote Data Center 16 may, for example, include console services, such as a central console for monitoring the status of multiple infrastructure management appliances. An example of console services are those operations described in connection with the “sweep and audit” function 114 shown in FIG. 5. For example, console services may provide statistics on how many times a customer has logged in to an infrastructure management appliance, and/or the average CPU utilization of an infrastructure management appliance. The monitoring of CPU utilization within an infrastructure management appliance is an example of steps taken in the disclosed system to support proactive management of an infrastructure management appliance. Such proactive management may enable further steps to be taken to address utilization issues without waiting for the customer to notice a problem, and potentially without customer action or interference with the customer's system operation.

In addition, event reporting functionality within the Remote Data Center 16 may include an event notification system such as a paging interface, electronic mail, instant messaging, or some other appropriate automated system for reporting issues that may be detected with respect to such multiple Infrastructure Management Appliances 10.

The disclosed system further includes a number of security features, including “hardened” Infrastructure Management Appliance 10 and Remote Data Center 16, as well as secure communications between the appliance service support personnel and the Infrastructure Management Appliance 10, and between the customer's IT personnel and the Infrastructure Management Appliance 10. In order to provide such security, the disclosed system may employ various technologies, including firewalls.

With regard to security functionality provided by the servers 30 in the Remote Data Center 16, an LDAP (Lightweight Directory Access Protocol) server program may be used to store account information for authentication purposes, such as a number of user accounts for appliance service support personnel having access to the disclosed system. Additionally, TACACS (Terminal Access Controller Access Control System) is an example of an access control protocol that may be used to authenticate appliance service support personnel logging onto the disclosed system, for example by maintaining username/password combinations necessary for accessing Remote Data Center 16 resources through the modems 18.

The Remote Data Center 16 may further include a Certificate Authority (CA) function that stores digital certificates for supporting SSL connections between infrastructure management appliances and customer IT personnel, as well as a Firewall (FW) function that may be used to form protected areas between the components of the disclosed system. For example, a domain edge type firewall may be used to protect the Remote Data Center 16 itself, while individual firewalls may also be provided for individual machines within the Data Center 16. With regard to securing access between the appliance service support personnel and the infrastructure management appliance, a protocol such as the secure shell (SSH) may be employed.

One example of user services functionality that may be provided by the Remote Data Center 16 is referred to herein as “trending”. The disclosed trending function of the Remote Data Center 16 stores raw monitoring data in a trend database maintained by the Infrastructure Management Appliance 10, and additionally in a supplemental database maintained in the Remote Data Center 16. For a given customer, trend data may be accumulated between the Infrastructure Management Appliance 10 and the Remote Data Center 16 over a significant period of time, covering up to a number of years. In connection with this capability, the Remote Data Center 16 may also include a “warehouse” database derived from the trend databases of multiple Infrastructure Management Appliances 10, but that has had all of the customer specific information removed.

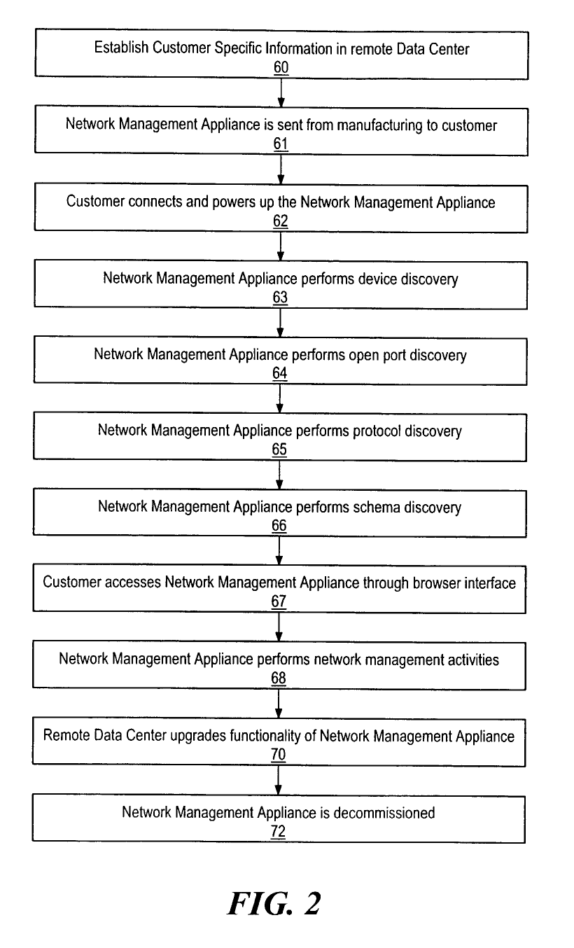

FIG. 2 is a flow chart showing steps performed during operation of the disclosed system. At step 60, customer specific information is established in the Remote Data Center 16. The information established in the Remote Data Center 16 typically includes the types and identities of resources to be managed for a given customer, and other characteristics of the execution environment in which a given Infrastructure Management Appliance 10 is to operate.

At step 61, an Infrastructure Management Appliance, such as the Infrastructure Management Appliance 10 of FIG. 1, is shipped from the manufacturing function of the Infrastructure Management Appliance provider to the customer. Advantageously, the Infrastructure Management Appliance 10 need not be loaded with any customer specific characteristics by the manufacturing function. In this way, the disclosed system enables similarly configured “vanilla” Infrastructure Management Appliances 10 to be shipped directly from manufacturing to various different customers.

At step 62, the Infrastructure Management Appliance 10 is delivered to the customer. Further at step 62, the customer connects the Infrastructure Management Appliance 10 to the customer's communication network, and then “power's up” the Infrastructure Management Appliance 10. The Infrastructure Management Appliance 10 then begins operation, and performs a series of self configuration steps 63-66, in which the Infrastructure Management Appliance 10 determines the customer's specific operational environment and requirements. At step 63, the Infrastructure Management Appliance 10 performs device discovery operations to determine a number of IP addresses that are currently used in association with devices present in the customer's network. At step 64, the Infrastructure Management Appliance 10 operates to determine the ports (UDP or TCP) that are open with respect to each of the IP addresses detected at step 63. Following step 64, in step 65, the Infrastructure Management Appliance 10 determines which protocols are in use within each port discovered at step 64. For example, step 65 may include a relatively quick test, like a telnet handshake over a port conventionally used for telnet to confirm that telnet is in use. At step 66, the Infrastructure Management Appliance 10 operates to perform schema discovery. Step 66 may include discovery of schema or version information, such as determining the specific information available through a protocol determined to be in use, such as SNMP (Simple Network Management Protocol). For example, certain information may be available through SNMP on certain customer machines, as indicated by the SNMP schema defining the MIB (“Management Information Base”) for a given device. Accordingly, such a determination at step 66 may indicate what information is available via SNMP on a given machine, including machine name, total number of packets moving through the device, etc. Other application schema may also be determined at step 66, such as MOF (Managed Object Format) schema. Moreover, during the discovery steps 63-66, the disclosed system may, for example determine whether certain database applications (such as ORACLE and/or SYBASE) are present on their standard port numbers.

At step 67, the customer may access the Infrastructure Management Appliance 10 in order to enter specific configuration information. For example, the customer IT personnel may employ the Browser 40 in the Local Management Station 14 of FIG. 1 in order to access the Infrastructure Management Appliance 10. Step 67 allows the customer to enter in configuration data not already available from the Data Center. For example, the customer IT personnel may customize the Infrastructure Management Appliance 10 during by initially provisioning the appliance at initialization time with basic operational parameters, and then subsequently provide further configuration information such as information relating to subsequently added users. Moreover, some managed customer resources require user names and passwords to be monitored, and such information may also be provided by the customer IT support personnel after power up at the customer site. Additionally, even if a resource is discovered automatically by the Infrastructure Management Appliance 10 in steps 63-66, the customer IT personnel may wish to disable management of the resource. This may be the case, for example, where a customer is only responsible for a subset of the total number of machines within the network, as is true for a department within a University network.

At step 68, the Infrastructure Management Appliance 10 enters a steady state, collecting information with regard to the operational status and performance of information technology resources of the customer network 12. The information collection performed at step 68 may include both event monitoring and active information collection, such as polling. For example, the activities of the Infrastructure Management Appliance 10 in this regard may include polling various managed objects using a management protocol such as SNMP (Simple Network Management Protocol). Such activities may further include use of a protocol such as PING (Packet INternet Groper), which uses a request/response protocol to determine whether a particular Internet Protocol (IP) address is online, and accordingly whether an associated network is operational. While SNMP and PING are given as examples of protocols that may be used by the Infrastructure Management Appliance at step 68, the disclosed system is not limited to use of SNMP or PING, and any appropriate protocol or process may be used as part of the network management activities performed by the Infrastructure Management Appliance 10 at step 68 for monitoring and acquiring information. Additionally, the Infrastructure Management Appliance 10 may issue service requests (“synthetic service requests”) to various services that are being monitored, in order to determine whether the services are available, or to measure the responsiveness of the services.

With regard to event monitoring, the Infrastructure Management Appliance 10 may, for example, operate at state 68 to receive and collect trap information from entities within the customer IT infrastructure. For example, SNMP traps provided by agents within various devices within the customer IT infrastructure may be collected and presented to customer IT support personnel within a single integrated event stream. Another example of an agent that could provide event information to the Infrastructure Management Appliance is an agent that scans logs created by a service or device. When such an agent detects an irregularity within such a log, it would provide an event message to the Infrastructure Management Appliance. While SNMP traps are described as an example of an event message, and agents are described as example of an event source, the present system is not so limited, and those skilled in the art will recognize that various other event messages and/or event sources may be employed in addition or in the alternative.

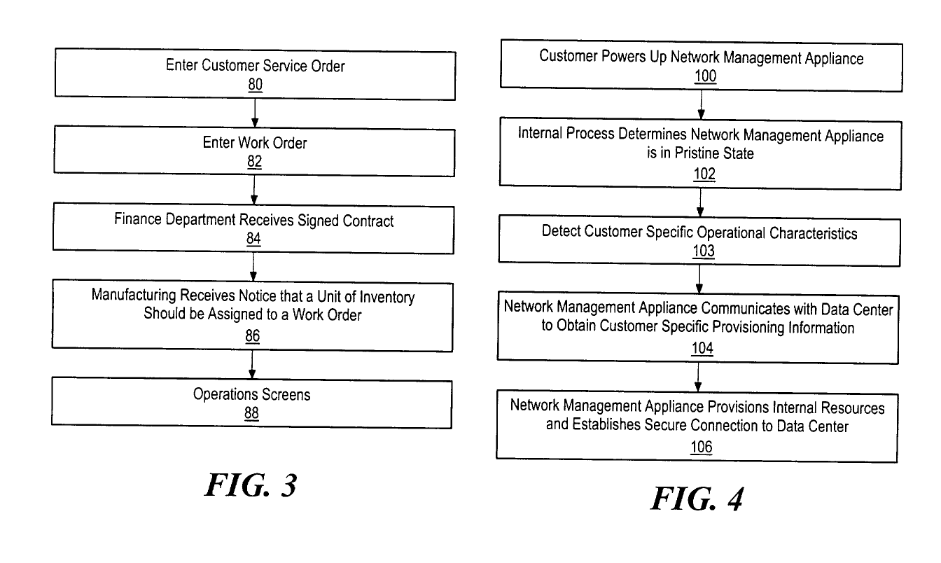

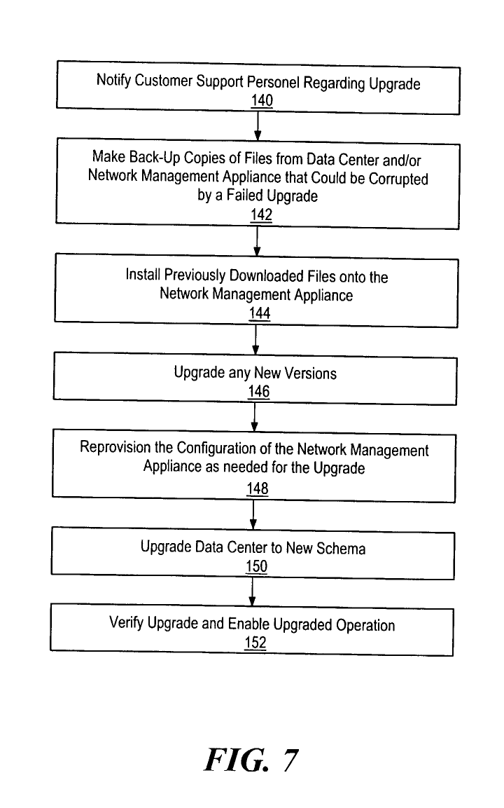

FIG. 3 is a flow chart showing steps performed during operation of the illustrative embodiment in order to establish customer specific information at the Remote Data Center 16. The customer specific information established through the steps shown in FIG. 3 may subsequently be used to configure and/or provision one of the disclosed Infrastructure Management Appliances 10 after it has been delivered to the customer premises. Delivery of such customer specific information may be accomplished through the steps described in FIGS. 6 and 7. The steps of FIG. 3 are an example of steps performed in connection with performing step 60 as shown in FIG. 2.

At step 80 of FIG. 3, a service order is entered into the disclosed system. For example, a user interface to one of the servers 30 shown in FIG. 1 may be provided to receive purchase orders and/or service orders. The purchase order entered at step 80 may indicate that a customer has ordered a Infrastructure Management Appliance 10. One example of a commercially available interface that may be employed in connection with the entry of a service or work order at step 80 is that provided in connection with the Action Request System® distributed by Remedy Corporation.

At step 82, a work order may also be entered through one of the servers 30 shown in FIG. 1. A similar or common interface as used in step 80 may be used to enter the work order at step 82. Through the entry of the customer service order at step 80, and the work order entered at step 82, various customer specific operational characteristics are provided into a database of customer specific information. The customer specific information thus provided may describe the specific managed objects that are to be monitored by a corresponding Infrastructure Management Appliance 10 that has been ordered by a specific customer. Such customer specific information may further indicate one or more management applications that have been licensed by that customer, and that are to be executed on the Infrastructure Management Appliance. All such customer specific information is then stored in one or more databases maintained by the Remote Data Center 16. Customer specific operational characteristics may be associated and indexed, for example, by one or more hardware embedded addresses of network interfaces of Infrastructure Management Appliances 10. In this way, the specific operational characteristics for a customer are associated with, and may be accessed by, the Infrastructure Management Appliance(s) 10 that are sent to that customer.

At step 84, a signed contract associated with the customer service order entered at step 80 and the work order entered at step 82 is received by a finance function of the business entity providing the infrastructure management appliance to the customer. The receipt of the signed contract, or other confirmation of the order at step 84 triggers delivery of a notice to the manufacturing function that a Infrastructure Management Appliance 10 should be assigned to the work order entered at step 82. The notice provided at step 86 may be delivered through any appropriate mechanism, such as electronic mail (email). A number of operation screens are then presented at step 88 through a user interface to enable entry of further data regarding delivery of the Infrastructure Management Appliance 10 to the customer. The actions triggered by the operation screens include loading of customer specific information from the Remote Data Center 16 to the Infrastructure Management Appliance 10. An example of steps performed in this regard is described in connection with FIGS. 6 and 7, which illustrate the loading of control information, such as application software, configuration information, and/or related schema from the Remote Data Center 16 to the Infrastructure Management Appliance 10.

FIG. 4 shows steps performed during operation of an illustrative embodiment of the disclosed system upon power up of the disclosed Infrastructure Management Appliance 10. The steps of FIG. 4 illustrate a process performed in connection with step 64 of FIG. 2. At step 100, the customer receives the Infrastructure Management Appliance 10, connects the interfaces of the Infrastructure Management Appliance 10 to the customer's internal network 12, and turns on the device's power. At step 102, the Infrastructure Management Appliance determines that it is in an initial state, and that it must therefore discover information regarding its operational environment, and obtain customer specific configuration information from the Remote Data Center 16. Accordingly, at step 103, the Infrastructure Management Appliance 10 detects some number of customer specific operational characteristics. For example, the Infrastructure Management Appliance 10 may operate at step 103 to determine a prefix for use when forming the dial up connection 20 shown in FIG. 1. Such a determination may, for example, be accomplished by trying one or more of the more common dial out prefixes. Such dial out prefixes are those numbers required to be entered into an internal telephone system prior to calling outside of the internal telephone network. Examples of common dial out prefixes are the numbers 8 and 9. The Infrastructure Management Appliance 10 may further operate at step 103 to determine its own Media Access Control (MAC) layer address, for indicating to the Remote Data Center 16 which user specific information is to be applied to the Infrastructure Management Appliance 10.

At step 104, the operations layer software of the Infrastructure Management Appliance 10 communicates with the Remote Data Center 16 to obtain customer specific information, such as provisioning information. The customer specific provisioning information obtained at step 104 may, for example, be obtained over the dial-up connection 20 between the Infrastructure Management Appliance 10 and the Remote Data Center 16 shown in FIG. 1. In the illustrative embodiment, a configuration file obtained by the Infrastructure Management Appliance 10 from the remote Data Center at step 104 includes information such as the IP address to be used by the Infrastructure Management Appliance 10, the system name of the Infrastructure Management Appliance 10, the default gateway for the customer network, information regarding the time zone in which the Infrastructure Management Appliance is located, a CHAP username and password, and possibly other information regarding the VPN to be established from the Infrastructure Management Appliance 10 and the remote Data Center.

Following receipt of the provisioning information obtained from the Remote Data Center 16 at step 104, the operations layer software of the Infrastructure Management Appliance 10 applies the provisioning information at step 106 to its internal resources, and establishes a secure connection to the Remote Data Center 16 at step 106. The secure connection to the Remote Data Center 16 may, for example, consist of the Virtual Private Network (VPN) 24 connecting the Infrastructure Management Appliance 10 and the Remote Data Center 16 (FIG. 1).

FIG. 5 shows interactions between the Remote Data Center 16 and the Infrastructure Management Appliance 10 of FIG. 1. As shown in FIG. 5, the Infrastructure Management Appliance 10 communicates with the Remote Data Center 16 in terms of sweep and audit activities 114, and trending 116. The sweep and audit activities 114, for example, represent interactions between the operations layer software and the system monitoring functionality in the servers 30 of the Remote Data Center 16. Such appliance monitoring may include actions designed to enable pro-active event detection with regard to failures or performance problems within the Infrastructure Management Appliance 10. In one embodiment, an Infrastructure Management Appliance 10 operates within the Remote Data Center 16 to monitor the status and performance of Infrastructure Management Appliances 10 located on customer premises that are associated with the Remote Data Center 16. The sweep and audit operations 114 between the Infrastructure Management Appliance 10 and the Remote Data Center 16 may, for example, form an underlying process that provides data to a central console function of the disclosed system. Specifically, the disclosed system operates to “sweep” the infrastructure management appliances in the field for operational status and perform a security “audit” of the infrastructure management appliances in the field for irregularities. Such auditing may, for example, including reading various logs of activities maintained at the respective infrastructure management appliances. Such logs may indicate who has logged in to a given system at what time.

Trending 116 illustrates the activities of the operations layer software within the Infrastructure Management Appliance 10 and a trending function within the server software 30 of the Remote Data Center 16. The trending 116 includes storing raw monitoring data collected by the Infrastructure Management Appliance 10 into one or more databases within the Remote Data Center 16. For example, the Infrastructure Management Appliance 10 may operate to store some predetermined number of days worth of raw monitoring data on behalf of the customer, e.g. monitoring data obtained over the preceding seven (7) days. Such data is referred to herein as “trend” data for a given customer. Each day, the Infrastructure Management Appliance 10 further operate to store one day's worth of trending data within a database of the Remote Data Center 16. This periodic pushing of data to the Remote Data Center 16 may be used to provide relatively long term trending data coverage. The trending data stored within the Infrastructure Management Appliance 10 and the Remote Data Center 16 may then be used to compile statistics on the performance of various services within the customer's information technology infrastructure. In a further aspect of the disclosed system, if the Infrastructure Management Appliance 10 is unable to successfully store monitoring data to the Remote Data Center 16 on a given day, for example due to lack of network availability, it may then operate to store that day's worth of monitoring data on the following day if possible. Moreover, trend data stored within the Remote Data Center 16 may be used to ensure that a predetermined number of day's worth of trend data, e.g. seven (7) days worth, is stored within the Infrastructure Management Appliance 10. For example, if the Infrastructure Management Appliance 10 loses its trend data, it may request a reload of some number of day's worth of trend data from the Remote Data Center 16.

FIG. 6 shows steps performed by the illustrative embodiment of the disclosed system in order to prepare for downloading operational information, such as a schema upgrade, to an Infrastructure Management Appliance 10. The steps shown in FIG. 6 may, for example, be performed by a master controller process within the operations layer 46 of the Infrastructure Management Appliance 10, in cooperation with the system control functionality of the Remote Data Center 16. The steps described in connection with FIGS. 6 and 7 illustrate an example of a process for implementing the functionality upgrade performed in step 70 of FIG. 2. The steps shown in FIGS. 6 and 7 further illustrate the steps used to download customer specific information from the Remote Data Center 16 to the Infrastructure Management Appliance 10. In an exemplary embodiment, the functionality upgrade performed through the steps shown in FIGS. 6 and 7 includes transfer of an upgraded XML schema to the Infrastructure Management Appliance 10 from the Remote Data Center 16. Alternatively, any type of information may be conveyed to the Infrastructure Management Appliance 10 through the steps shown in FIGS. 6 and 7, including one or more management application programs, executable code, configuration information, and/or other information appropriate for upgrading the functionality of a specific implementation of the disclosed system.

In step 120 of FIG. 6, the system control functionality of the Remote Data Center 16 verifies that the Infrastructure Management Appliance 10 is reachable from the Remote Data Center 16. For example, the Remote Data Center 16 may determine whether or not the Infrastructure Management Appliance 10 is reachable over the secure connection 24 between the Remote Data Center 16 and the Infrastructure Management Appliance 10 at step 120.

If the Remote Data Center 16 determines that the Infrastructure Management Appliance 10 is reachable at step 120, then at step 122 the Remote Data Center 16 verifies that any services within the Infrastructure Management Appliance 10 that are required to perform the upgrade are available, such as the database and the master controller process within the Infrastructure Management Appliance 10. In the case where all such necessary services are determined to be available, the Remote Data Center 16 verifies at step 124 that the current functionality within the Infrastructure Management Appliance 10 is at an expected revision level. For example, in the case of an upgrade from revision 1.0 XML schema to revision 1.1 XML schema, the Remote Data Center 16 may verify that the current schema revision in the Infrastructure Management Appliance 10 is 1.0 at step 124. Similarly, the Remote Data Center 16 verifies at step 126 that the functionality upgrade information in the Remote Data Center 16 is at the appropriate revision at step 126. Thus the Remote Data Center 16 would verify that the upgrade information in the above example would be revision 1.1 schema.

At step 128, the Remote Data Center 16 verifies that the contents of a configuration file on the Infrastructure Management Appliance 10 matches a current record of the configuration file stored within the Remote Data Center 16. Information within the configuration file may, for example, indicate which management applications are currently supported on the Infrastructure Management Appliance 10 prior to performing the upgrade.

In the case where any of the verifications in steps 120, 122, 124, 126, 128 and 130 fails, the disclosed system may notify a system operator. In such an event, the system operator may then take whatever actions are required to resolve the detected problem. Those skilled in the art will recognize that the order of the verifications in steps 120, 122, 124, 126, 128 and 130 as shown in FIG. 7 is purely for purposes of illustration, and that these verifications may alternatively be performed in other orders.

Otherwise, in the event that all verifications in step 120, 122, 124, 126, 128 and 130 pass, then at step 130 the Remote Data Center 16 will determine whether the upgrade file(s) are present in the Infrastructure Management Appliance 10. The disclosed system may further verify that a checksum for one or more of the files used for the upgrade matches a stored copy of the checksum for the files. If any of the files necessary for the upgrade are not present within the Infrastructure Management Appliance 10, or have been corrupted, then the Remote Data Center 16 downloads those files to the Infrastructure Management Appliance 10 at step 130.

FIG. 7 shows steps performed by the illustrative embodiment of the disclosed system to upgrade schema within a Infrastructure Management Appliance 10. The steps shown in FIG. 7 are performed in the event that the verifications described with reference to FIG. 6 succeed, thus indicating that the Infrastructure Management Appliance 10 is ready to be upgraded. At step 140 of FIG. 7, notification is provided to the customer's support personnel regarding the upgrade. This notification is provided so that the customer's IT support personnel can inform user's of the customer's systems that the Infrastructure Management Appliance 10 will not be available during the upgrade. At step 142, back-up copies are made of files on the Infrastructure Management Appliance 10 and/or files stored in the Remote Data Center 16 that could be jeopardized during a failed upgrade process. Such backup copies may be stored either within the Infrastructure Management Appliance 10, or within a system located in the Remote Data Center 16.

At step 144 of FIG. 7, the upgrade file or files, such as those downloaded to the Infrastructure Management Appliance 10 at step 130 of FIG. 6, are installed in the Infrastructure Management Appliance 10. Step 130 may include opening archived files that were previously loaded onto the Infrastructure Management Appliance 10, and/or removing any old software packages no longer used in the upgraded configuration. At step 146, the disclosed system operates to upgrade any management applications on the Infrastructure Management Appliance 10 for which new versions have been provided.

At step 148 of FIG. 7, the disclosed system re-provisions the Infrastructure Management Appliance 10 as needed to support any newly upgraded applications. Schema being used in the Remote Data Center 16 systems is then upgraded at step 150. Finally, at step 152, the upgraded files are confirmed to be present in both the Infrastructure Management Appliance 10 and the systems of the Remote Data Center 16, and operation is re-enabled.

System for Providing a Namespace to a Computer Program

As it is generally known, a namespace for a computer program may be defined as a name or group of names that are defined according to some naming convention. A flat namespace uses a single, unique name for every device. For example, a small Windows (NetBIOS) network requires a different, made-up name for each computer and printer. The Internet uses a hierarchical namespace that partitions the names into categories known as top level domains such as .com, .edu and .gov, etc., which are at the top of the hierarchy.

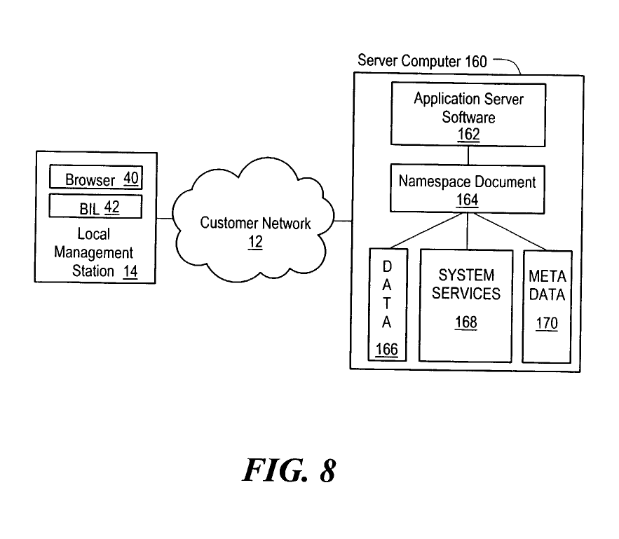

In a further aspect of the disclosed system, as shown beginning in FIG. 8, a number of components shown which provide a single hierarchical namespace for aggregating XML services, and which provide low level system and directory services across a number of XML services, such as access control, directory listing, and documentation. The components providing such hierarchical namespace further operate to provide a single, unified interface to persistence, and allow interoperability of XML services within the provided namespace.

In the illustrative embodiment of FIG. 8, the local management station 14, including internet browser software 40 and browser integration layer software 42, is shown communicating over the customer network 42 with a server computer 160. The server computer 160 may be any computer system with which the local management station 14 can communicate, such as, for example, the Network Management Appliance 10, the server systems 28 in the Remote Data Center 16, or the NOC server 34 in the Remote Information Center 36 of FIG. 1. The techniques for providing a namespace disclosed herein are applicable to any execution environment, and the server computer 160 may consist of any specific computer system having one or more processors for execution of a number of computer programs stored in a memory or other type of computer program storage device.

The server computer 160 of FIG. 8 is further shown including application server software 162, a namespace document 164, data 166, system services 168, and meta-data 170. During operation of the components shown in FIG. 8, a number of remote method invocations are performed by software executing on the local management station 14 with respect to software objects stored on the server computer 160. These remote method invocations are passed from the local management station 14, across the customer network 12, to the server computer 160, and received for processing by the application server software 162. The application server software 162, employs the namespace document 164 to map various names of data, program code, and/or meta-data resources within the remote method invocations, to data and/or program code located within the data 166, system services 168 and/or meta-data 170. In this way, the components of the disclosed system shown in FIG. 8 operate provide a name space for data access, dispatching of system calls, and access to metadata. The components of FIG. 8 may thus provide a global naming system of unique names for at least objects within the server computer 160. In an illustrative embodiment, the names used are Uniform Resource Locators (“URLS”), which guarantee uniqueness across all systems. Accordingly, the present system is not limited to the example shown in the illustrative embodiment of FIG. 8, which may provide unique naming at least within the server computer 160.

In the illustrative embodiment, namespace document 164 of FIG. 8 consists of a single physical XML document that resides on a single host on a network, shown for example as server computer 160. The namespace document 164 represents a virtual file system for the XML services that are available on the server computer 160, for example within the system services 168. The virtual file system consists of XML nodes within the namespace document 164. The XML nodes within the namespace document 164 can be either directory type or file type nodes.

Directory nodes within the XML nodes of the namespace document 164 effectively provide file system directories. For example, the namespace might support the following physical or virtual directories:

/usr/bin

/app/report/

/cpe/report/

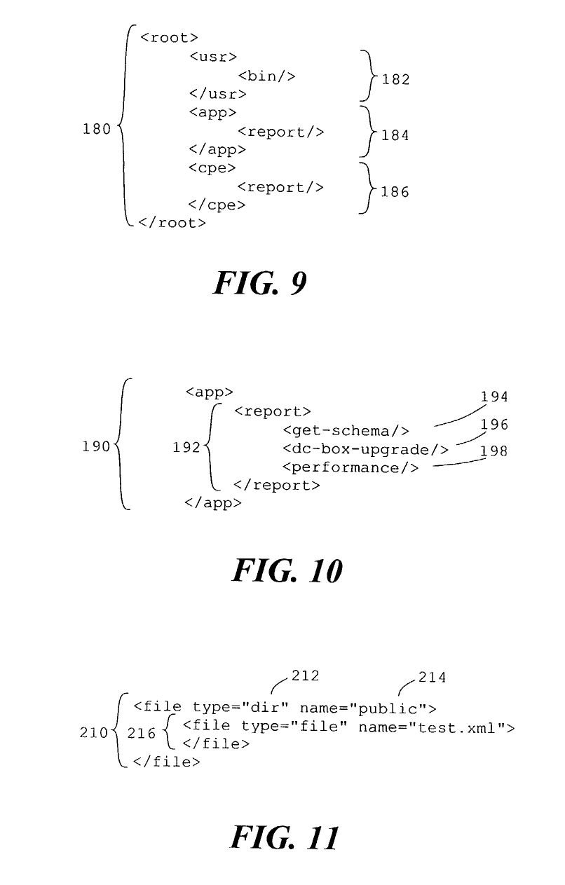

In such an example, the namespace document 164 might appear, at least in part, as the XML code 180 shown in FIG. 9. The XML code 180 is shown including a node 182 corresponding to the /usr/bin directory, a node 184 corresponding to the /app/report/ directory, and a node 186 corresponding to the /cpe/report/ directory.

A file node is a specialized node that refers to a physical file or program on a host, such as the server computer 160 of FIG. 8. For example, a host may have the following virtual file nodes (these files may be used by the code within the application server software 162 of FIG. 8):

get-schema.pl

dc-box-upgrade.pl

performance.xml

For example, as shown in the illustrative embodiment of FIG. 10, get-schema.pl and dc-box-upgrade.pl are programs in the Perl programming language that exist on the server computer 160, and that are operative to support schema migration within the server computer 160 when executed. Further in the illustrative embodiment the performance.xml file is an XML file that describes the layout of user interface reports, for example as provided by the server computer 160 to the local management station 14. Accordingly, the XML code 190 of FIG. 10 is shown including a report node 192 including get-schema file node 194, dc-box-upgrade file node 196, and performance file node 198. As discussed further below, the file nodes can be differentiated from directories through the use of system level services (e.g. a directory listing).

A system area provided by the namespace document 164 provides the attributes that distinguish the files from the directories in the file system. The system area is denoted by a <system> node that is a child of <root>. The system area is a direct mirror of the XML file system provided through the namespace document 164, but describes the file system in terms of <file> elements.

The <file> elements in the system area of the namespace document 164 distinguish between two types of files: directories and files. This is denoted via a type attribute of the file element. Valid types include “dir” or “file”. For example, FIG. 11 shows a file node 210 having a type attribute value of “dir” 212, thus indicating that it a directory, and a name attribute value of “public” 214. FIG. 11 further illustrates a file 216 in the directory 210 named “test.xml.”

In the illustrative embodiment, the following attribution is currently supported for <file> elements in the system area of the namespace document 164:

Access control (<access-specification>)—this attribute specifies the permissions for a file (read, write, delete, add) for one or more named users.

Physical file (<physical>)—this attribute specifies an actual file in the physical file system of the host computer that is referenced by this file node. For example, the illustrative embodiment supports two types of physical attribution for files: “XML” and “Xlet”. A value of “XML” indicates that the file is an XML file, while a value of “Xlet” indicates that the file is an executable file.

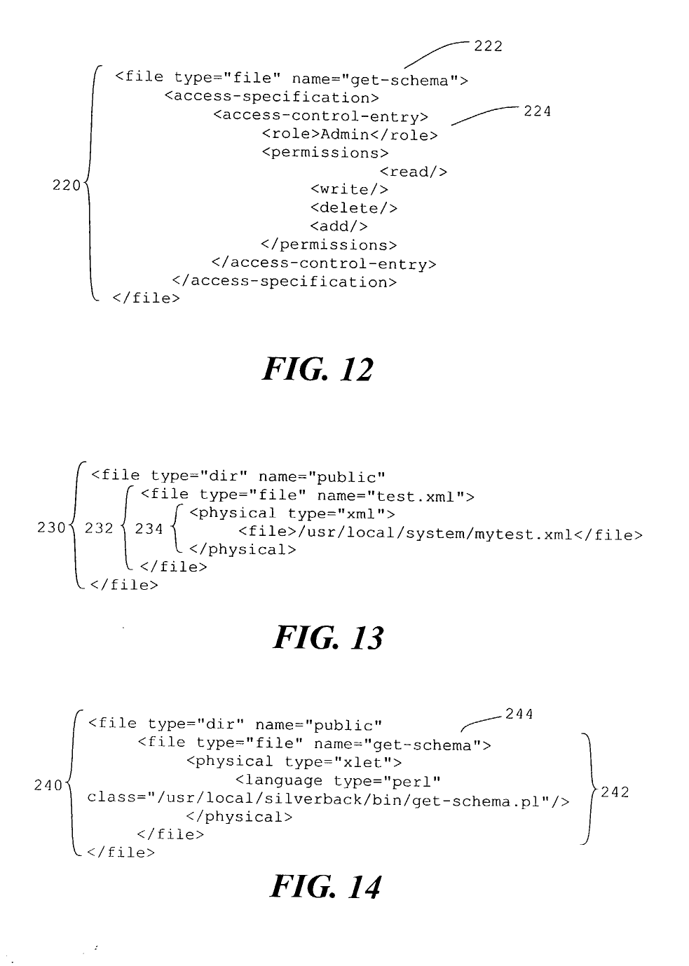

The XML code 220 shown in FIG. 12 shows the access control attribution for a file type node having a name attribute value of “get-schema” 222. The XML code 220 further employs a <role> node 224, to specify that the Admin user has read, write, delete, add and execute permissions for the file. In the illustrative embodiment, if permissions are not specified, they are inherited from a directory's parent node within the namespace document 164, in the same manner as within a physical file system.

An example is now described with reference to FIG. 13, which specifies the physical attribution for an XML file. In the illustrative embodiment, physical attribution is only specified for file nodes. The XML code of FIG. 13 includes a file type node 232 called “test.xml” in a directory node 230 called “public”. The file node 232 includes a physical node 234 indicating a type of “XML”, and referring to a physical file “mytest.xml” in /usr/local/system of the physical file system on the server computer 160 of FIG. 8.

Another example of physical attribution is shown within the directory file node 240 of FIG. 14, for an executable file node 242. The executable file node 242 is identified by the type attribute “xlet”, and is referred to herein as an “xlet”. The executable file node 242 has a name of “get-schema” 244, and is located in the “public” directory defined by the directory node 240.

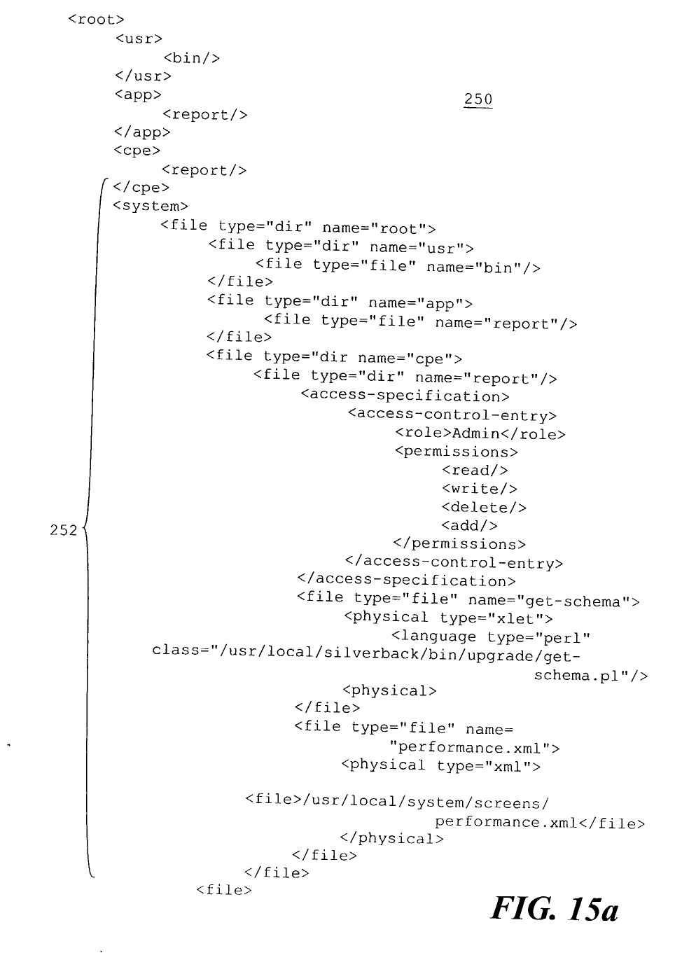

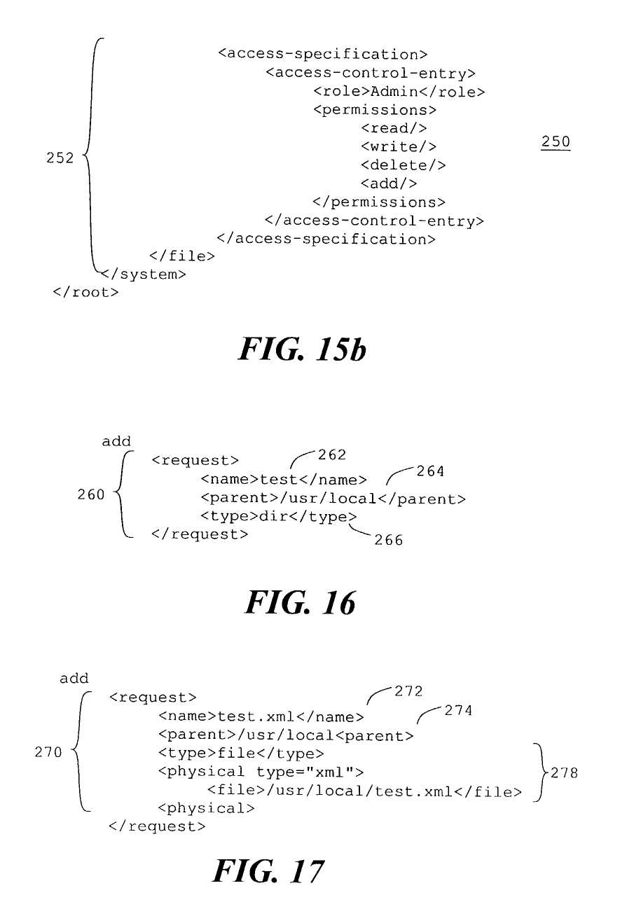

In order combine the above examples into a single example directory, the XML 250 of FIG. 15(a) and FIG. 15(b) illustrates an example of a complete XML document corresponding to the namespace document 164 of FIG. 8, including its underlying system area 252. The structure of the illustrated system file system is highly readable and clarifies the coupling between directory nodes and file nodes.

The disclosed system includes a number of system services that are considered “OS” level services for the namespace provided by the namespace document 164. These system services include the following:

add—Adds a file/directory to XFS

cp—Copies an XFS file/directory from one location to another

mv—Moves an XFS file/directory from one location to another

rm—Removes an XFS file/directory

ls—Performs a directory listing

exec—Executes an XML service

The above system services are, for example, exposed in the illustrative embodiment via a command line interface to the server computer 160, and/or through other protocols such as HTTP (HyperText Transfer Protocol). As will be recognized by those skilled in the art, the number of system services provided by the disclosed system may be significantly expanded. For example, such expanded system services may include a broad set of services for working with XML and XML specific services (e.g. mapping of XML to databases, XSL (extensible Stylesheet Language), XPath (XML PATH Language).

The namespace document 164 further supports the ability to dynamically add files and/or directories into a running system. This can be accomplished through system services (168 in FIG. 8) provided through the namespace document.

To add a directory into a running system, the “add” command 260 of FIG. 16 may be employed. In the example of FIG. 16, the directory to be added has a name of “test”, and a parent node of /usr/local. The type node 266 indicates that the node to be added is a directory node.

To add an XML file into a running system, the “add” command 270 of FIG. 17 may be employed. In the illustrative embodiment, all physical files that are references must already be staged to the physical file system prior to an add. As shown in FIG. 17, the name node 272 indicates that the XML file to be added is called “test.xml”, the parent node 274 indicates that the XML file is to be added as a child of /usr/local, and the type node 276 indicates that the node being added is a file node. Further, the physical node 278 indicates that node being added is an XML file, and the physical location of the actual corresponding file (/usr/local/test.xml) on the host computer.

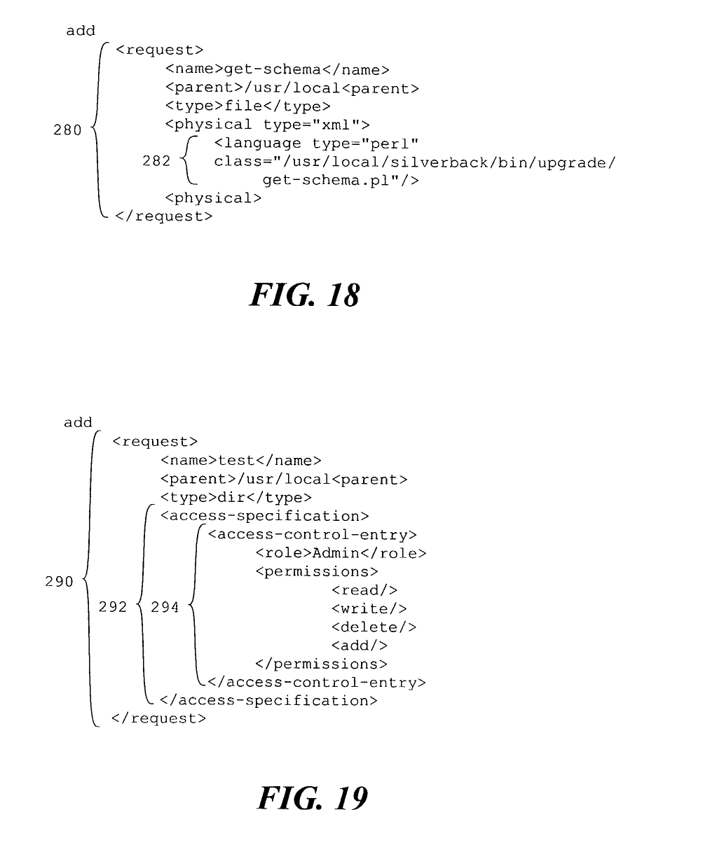

To add an executable file (referred to as an “Xlet” herein) into the namespace provided by the namespace document 164, the add command of FIG. 18 may be employed including the XML code 280. As shown in FIG. 18, the language node 282 indicates that the language in the file is the Perl programming language. The class attribute specifies the path to the executable file.

Permissions can be specified with an add operation as shown in FIG. 19, including the XML code 290. As shown in the XML code 290, the access specification node 292 includes an access specification 294 indicating that Admin users have read, write, delete, and add permission with respect to the contents of the “test” directory node being added. By the add operation shown in FIG. 19.

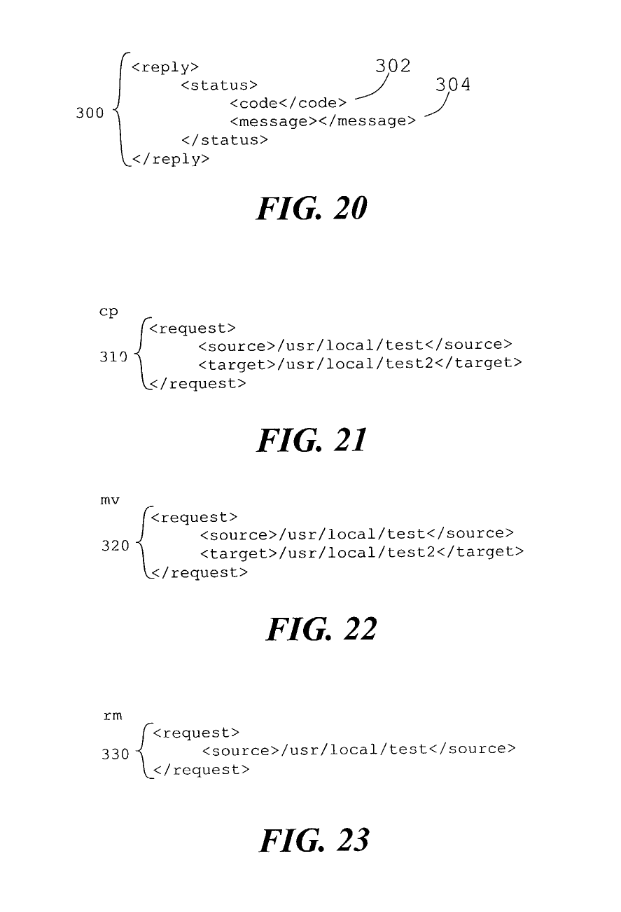

Further in the illustrative embodiment, each of the system service commands described above returns output of the form shown in FIG. 20 by XML code 300. For purposes of illustration, the <code> 302 is an integer denoting the error code (zero for success; non-zero for failure), and the <message> 304 is a string that denotes further detail on the error code.

The disclosed system supports the ability to dynamically copy, move or delete files and/or directories in the provided namespace, using the illustrative set of system services. For example, in order to copy a file/directory from one location in namespace to another, the copy command in FIG. 21 may be used, including the XML code 310, which includes indication of both a source location and destination location within the host computer system.

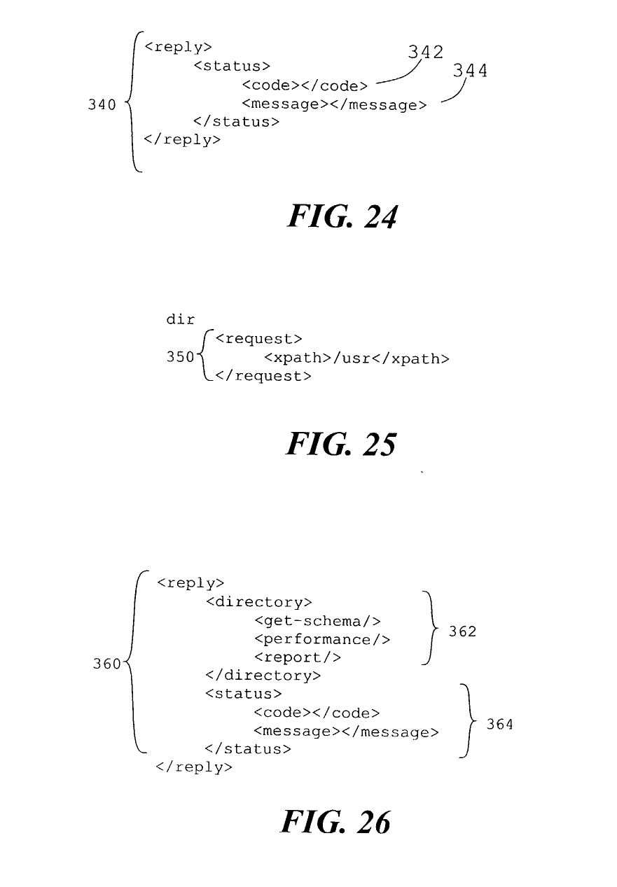

FIG. 22 illustrates a move command which may be used to move a file/directory from one location in the namespace to another, using the XML code 320 to indicate the source and target locations for the move. Similarly, FIG. 23 shows an example of a remove command using XML code to indicate the file to be removed from the namespace. Each of the system service commands shown in FIGS. 21-23 returns output of the form shown in FIG. 24, in which the XML code 340 includes a <code> 342 that is an integer denoting the error code (zero for success; non-zero for failure), and a <message> 344 that is a string denoting further detail on the error code.

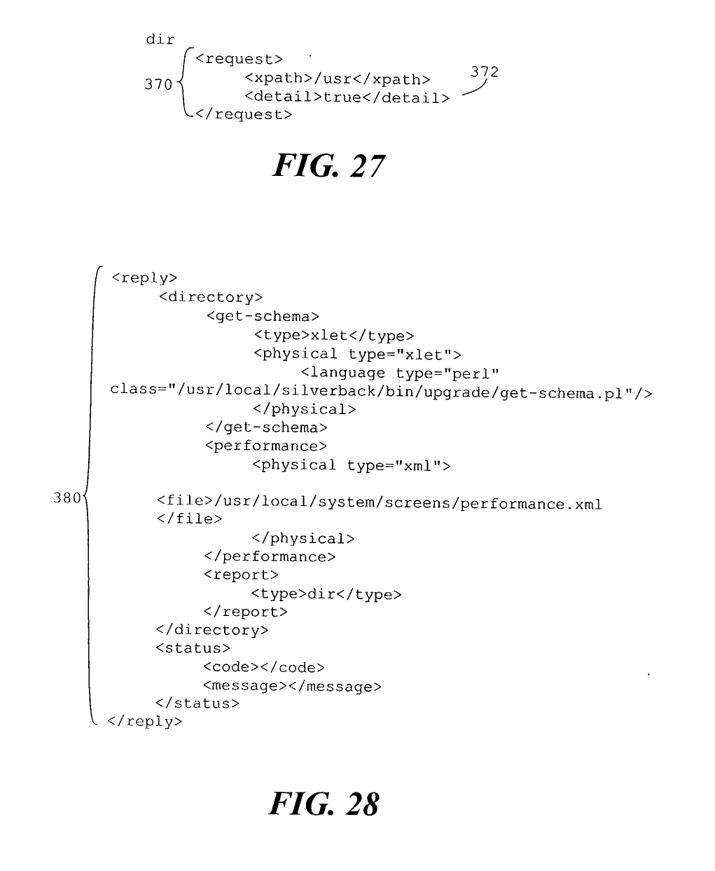

The disclosed system further supports the ability to get a listing of any directory in the namespace. In this regard, FIG. 25 shows a directory command using XML code 350 to generate a simple directory listing request, for the /usr directory. For purposes of illustration, the request shown in FIG. 25 causes the output in FIG. 26 to be returned, indicating the contents of the /usr directory in the directory node 362, and the status of the request in the status node 364. FIG. 27 is an example of a directory request that requests additional detail through the XML code 370, indicated by the value of the detail node 372. For purposes of illustration, in the illustrative embodiment, the directory command shown in FIG. 27 causes the output shown in FIG. 28 to be returned, including the XML code 380.

In the illustrative embodiment of the disclosed system, any file node can be executed. As described above, there are two types of file nodes: XML and Xlets. The execution of an XML file results in its XML being returned to the caller. The execution of an Xlet results in it being executed, for example on the local host, and its results being returned to the caller.

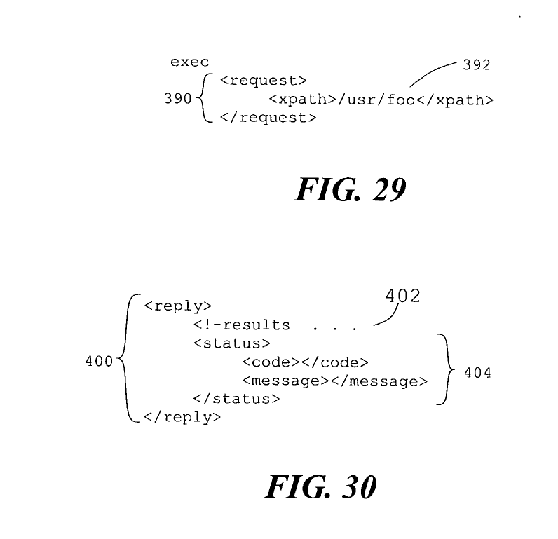

FIG. 29 shows an example of an execute request for an Xlet, including XML code 390 indicating that the executable file /usr/foo is to be executed. The program execution resulting from the request shown in FIG. 29 will, for example, return the output shown in FIG. 30, including XML code 400. The XML code 400 within the output shown in FIG. 30 includes a results part 402, which may include anything generated or indicated as a result of the request program execution, as well as a status part 404.

Those skilled in the art should readily appreciate that programs defining the functions of the disclosed system and method for determining deadlock-free routes can be implemented in software and delivered to a system for execution in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem. In addition, while the illustrative embodiments may be implemented in computer software, the functions within the illustrative embodiments may alternatively be embodied in part or in whole using hardware components such as Application Specific Integrated Circuits, Field Programmable Gate Arrays, or other hardware, or in some combination of hardware components and software components.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

What is claimed is:

1. A system for providing a name space to a computer program, comprising:
a document stored on a computer system, said document including a plurality of nodes, each of said nodes defined using a definitional markup language, wherein said plurality of nodes includes at least one directory node and at least one file node; and
wherein said document represents a file system for at least one service available on said computer system.

2. The system of claim 1, wherein said document further comprises a system area, said system area including at least one type attribute corresponding to each of said at least one file node and said at least one directory type node, wherein said at least one type attribute distinguishes between said at least one file type node and said at least one directory type node.

3. The system of claim 2, wherein said system area of said document further comprises at least one access control attribute corresponding to each of said at least one file type node.

4. The system of claim 3, wherein said system area of said document further comprises at least one physical file attribute corresponding to each of said at least one file type node, wherein said physical file attribute defines a location of a physical file corresponding to said at least one file type node.

5. The system of claim 3, wherein said at least one access control attribute specifies actions permitted to be performed by at least one user.

6. The system of claim 5, wherein said actions comprise read, write, delete and add actions.

7. The system of claim 1, wherein said at least one directory node represents a system directory.

8. The system of claim 1, wherein said definitional markup language comprises Extensible Markup Language (XML).

9. A method for providing a name space to a computer program, comprising:
receiving a name from said computer program;
determining, responsive to a document stored on a computer system, a resource associated with said name, wherein said document includes a plurality of nodes, each of said nodes defined using a definitional markup language, wherein said plurality of nodes includes at least one directory node and at least one file node, wherein said document represents a file system available to said computer program and said resource associated with said name; and
providing access to said resource to said computer program.

10. The method of claim 9, wherein said determining further comprises examining at least a portion of a system area within said document, said system area including at least one type attribute corresponding to each of said at least one file node and said at least one directory type node, wherein said at least one type attribute distinguishes between said at least one file type node and said at least one directory type node.

11. The method of claim 10, wherein said examining of said system area further comprises examining at least one access control attribute, wherein said system area includes at least one access control attribute corresponding to each of said at least one file type node.

12. The method of claim 11, wherein said examining of said system area further comprises examining at least one physical file attribute, wherein said system area of said document further includes at least one physical file attribute corresponding to each of said at least one file type node, and wherein said physical file attribute defines a location of a physical file corresponding to said at least one file type node.

13. The method of claim 11, further comprising determining whether a requested action is permitted, and wherein said at least one access control attribute specifies actions permitted to be performed by at least one user.

14. The method of claim 13, wherein said requested action comprises one of set consisting of read, write, delete and add.

15. A computer program product including a computer readable medium, said computer readable medium having a computer program stored thereon, said computer program for providing a name space to a computer program, said computer program comprising:
program code for receiving a name from said computer program;
program code for determining, responsive to a document stored on a computer system, a resource associated with said name, wherein said document includes a plurality of nodes, each of said nodes defined using a definitional markup language, wherein said plurality of nodes includes at least one directory node and at least one file node, wherein said document represents a file system available to said computer program and said resource associated with said name; and
program code for providing access to said resource to said computer program.

16. A system for providing a name space to a computer program, comprising:
means for receiving a name from said computer program;
means for determining, responsive to a document stored on a computer system, a resource associated with said name, wherein said document includes a plurality of nodes, each of said nodes defined using a definitional markup language, wherein said plurality of nodes includes at least one directory node and at least one file node, wherein said document represents a file system available to said computer program and said resource associated with said name; and
means for providing access to said resource to said computer program.
